(19) United States
(12) Patent Application Publication
(10) Pub. No.: US 2008/0115261 A1
(43) Pub. Date: May 22, 2008

(54) Protective garment having outer shell, lining system, and front closures not overlying one another

(75) Inventors: William L. Grilliot, Dayton, OH (US); Mary I. Grilliot, Dayton, OH (US); Patricia K. Waters, Tipp City, OH (US)

Correspondence Address: WOOD, PHILLIPS, KATZ, CLARK & MORTIMER, 500 W. MADISON STREET, SUITE 3800, CHICAGO, IL, 60661, US

(73) Assignee: Morning Pride Manufacturing, L.L.C.

(21) Appl. No.: 11/603,481

(22) Filed: Nov. 22, 2006

(51) Int. Cl. A62B 17/00; A41D 13/02; A41D 3/02; A41D 1/00

(52) U.S. Cl. 2/458; 2/79; 2/81; 2/85; 2/97

(57) ABSTRACT

In a protective garment comprising an outer shell and a lining system, the outer shell has a front closure, which is openable and closeable, and the lining system has a front closure, which is openable and closeable. Each front closure extends along a generally vertical path when said front closure is closed while the protective garment is being worn by a wearer standing vertically. The front closures are staggered so as not to overlie one another when the front closures are. closed while the protective garment is being worn. In one embodiment, the front closure of the outer shell is arranged so as to be approximately centered between two arm-covering portions of the protective garment, when the front closures are closed while the protective garment is being worn.

### STATEMENT REGARDING FEDERALLY SPONSORED RESEARCH OR DEVELOPMENT

This invention was made with Government support under Contract No. W91CRB-04-C-027 awarded by the U.S. Department of the Army. The Government has certain rights in the invention.

### TECHNICAL FIELD OF THE INVENTION

This invention pertains to a protective garment having an outer shell and a lining system, each having a front closure. This invention provides that the front closures do not overlie one another when the front closures are closed while the protective garment is being worn.

### BACKGROUND OF THE INVENTION

Commonly, a protective garment, as described in the preceding paragraph is a protective coat or protective coveralls, as worn by a firefighter or by an emergency rescue worker, who also may wear a face mask for a self-contained breathing apparatus. Commonly, the protective garment has an outer shell and a lining system, which may comprise a moisture barrier worn beneath and against the outer shell and a thermal barrier worn beneath and against the moisture barrier, and complies with National Fire Protection (NFPA) standards, such as the NFPA 1971 (2000) standard.

Commonly, the outer shell has a front closure, which is openable and closeable, as exemplified by a zipper, by a series of snap fasteners, or by a series of buttons coacting with buttonholes. Commonly, the lining system has a front closure, which is openable and closeable, as exemplified by a zipper, by a series of snap fasteners, or by a series of buttons coacting with buttonholes. Commonly, when the protective garment is worn by a wearer standing erectly and the front closures are closed, the front closures extend along generally vertical paths.

Heretofore, it has been known for the front closure of the outer shell to overlie the front closure of the lining system when the protective garment is worn and the front closures are closed, whereupon the front closures overlying one another may be unduly difficult for the wearer to close near the chin of the wearer, particularly if the wearer also is wearing a face mask for a self-contained breathing apparatus. Heretofore, when the protective garment has two sleeves or arm-covering portions, it has been known for the overlying closures to be approximately centered between the sleeves or arm-covering portions.

Moreover, it has been known to arrange the overlying closures to be laterally offset toward one of the sleeves or arm-covering portions, so that it may be less difficult for the wearer to close the overlying closures near the chin of the wearer, particularly if the wearer is wearing a face mask for a self-contained breathing apparatus. However, it is disadvantageous for the overlying closures to be laterally offset toward one of the sleeves or arm-covering portions, as the front closure of the outer shell then occupies a space that would be otherwise available for a pocket to hold other gear, such as a two-way radio.

### SUMMARY OF THE INVENTION

This invention provides a protective garment comprising an outer shell and a lining system. The outer shell has a front closure, which is openable and closeable, and the lining system has a front closure, which is openable and closeable. Each front closure extends along a generally vertical path when said front closure is closed while the protective garment is being worn by a wearer standing vertically. This invention provides that the front closures are staggered so as not to overlie one another when the front closures are closed while the protective garment is being worn.

If the protective garment has two limb-covering portions, one of the front closures may be arranged so as to approximately centered between the limb-covering portions, when the front closures are closed while the protective garment is being worn. The limb-covering portions may be arm-covering portions. The front closure of the outer shell may be thus arranged.

### BRIEF DESCRIPTION OF THE DRAWINGS

FIG. 1 is a fragmentary, pictorial view of a protective garment embodying this invention, as worn by a firefighter. As illustrated in FIG. 1, a front closure of an outer shell of the protective garment is opened, while a front closure of a lining system of the protective garment is closed.

FIG. 2 is a fragmentary, pictorial view, in which the firefighter is illustrated as wearing other gear including a face mask for a self-contained breathing apparatus and which is similar to FIG. 1 in other respects, except that both front closures are closed.

FIG. 3 is a fragmentary, sectional view, which is taken along line 3-3 in FIG. 2, in a direction indicated by arrows.

### DETAILED DESCRIPTION OF THE ILLUSTRATED EMBODIMENT

As illustrated, a protective garment 10 embodying this invention may be a protective coat or protective coveralls and, thus, has a main or torso-covering portion 12 and two sleeves or arm-covering portions 14. As illustrated, the protective garment 10 is being worn by a firefighter, who also is wearing a protective hood 16, which extends upwardly from the main or torso-covering portion 12, and who also is wearing a face mask 18 for a self-contained breathing apparatus.

Throughout the main or torso-covering portion 12 and the sleeves or arm-covering portions 14, the protective garment 10 has an outer shell 20 and a lining system 30, which comprises a moisture barrier 30a worn beneath and against the outer shell 20 and a thermal barrier 30b worn beneath and against the moisture barrier. Preferably, the protective garment 10 conforms to the NFPA 1971 (2000) standard.

The outer shell 20 has a front closure 22, which is openable manually and closeable manually. The lining system 32 has a front closure 32, which is openable manually and closeable manually. Each front closure 22, 32, is arranged so as to extend along a generally vertical path when said front closure 22, 32, is closed while the protective garment 10 is being worn by a wearer standing vertically. Each front closures 22, 32, is exemplified by a zipper, as illustrated, by a row of snap fasteners, or by a row of buttons coacting with buttonholes.

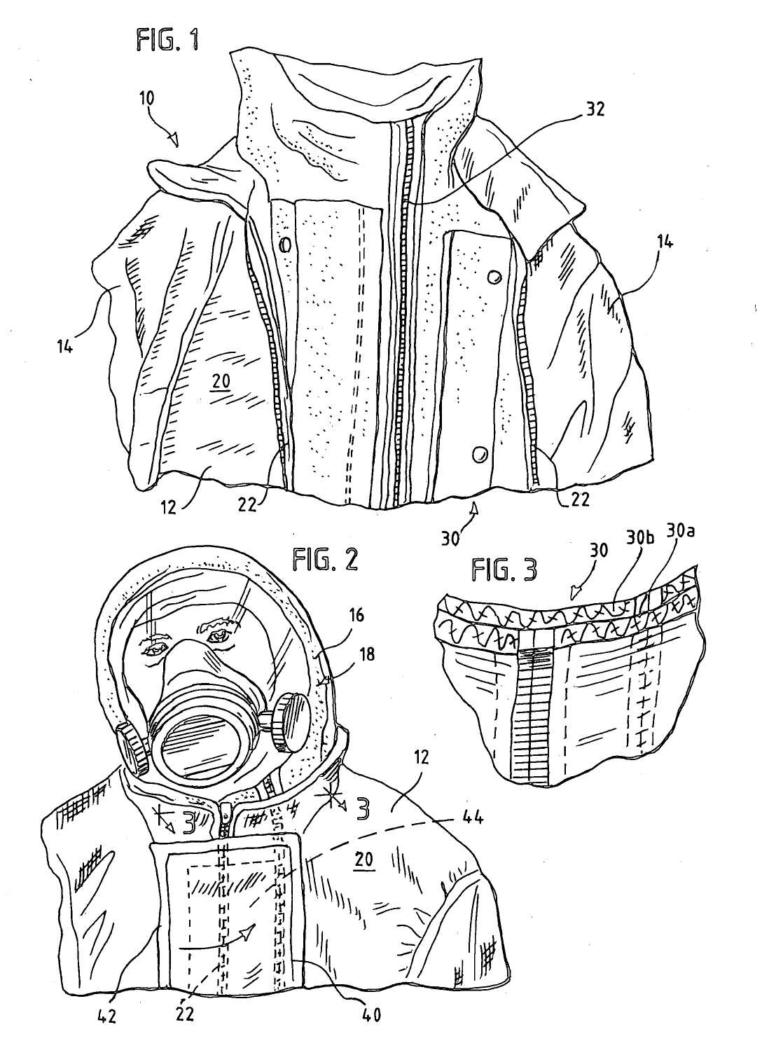

Moreover, the outer shell 20 has a flap 40, which in a closure-covering position is adapted to cover the front closure 22 when the front closure 22 is closed, as illustrated in FIG. 2, which is foldable along one edge 42 of the flap 40, between the closure-covering position and other positions, which are exemplified by its position in FIG. 1, and which in the closure-covering position is attachable detachably to the outer shell 20, at a front area of the main or torso-covering portion 12, via a hook-and-loop fastener 44.

This invention provides that the front closure 22 of the outer shell 20 and the front closure 32 of the lining system 30 are staggered so as not to overlie one another when the front closures 22, 32, are closed while the protective garment 10 is being worn. As illustrated, the front closure 22 of the outer shell 20 is arranged so as to be approximately centered between the sleeves or arm-covering portions 14, while the front closure 32 of the lining system 30 is arranged so as to be laterally offset toward one of the sleeves or arm-covering portions 14, i.e., toward the left from the vantage of the wearer.

Alternatively, the front closure 32 of the lining system 30 is arranged so as to be approximately centered between the sleeves or arm-covering portions 14, while the front closure 30 of the outer shell 30 is arranged so as to be laterally offset toward one of the sleeves or arm-covering portions 14. Alternatively, the front closure 32 of the lining system 30 is arranged so as to be laterally offset toward one of the sleeves or arm-covering portions 14, while the front closure 30 of the outer shell 30 is arranged so as to be laterally offset toward the other of the sleeves or arm-covering portions 14.

1. A protective garment comprising an outer shell and a lining system, the outer shell having a front closure is configured to be openable and closeable to allow donning of the outer shell, and the lining system having a front closure configured to be openable and closeable to allow donning of the lining system, each front closure extending along a generally vertical path when said front closure is closed while the protective garment is being worn by a wearer standing vertically, wherein the front closures are staggered so as not to overlie one another when the front closures are closed while the protective garment is being worn.

2. The protective garment of claim 1, wherein the protective garment has two limb-covering portions and wherein one of the front closures is arranged so as to be approximately centered between the limb-covering portions, when the front closures are closed while the protective garment is being worn.

3. The protective garment of claim 1, wherein the protective garment has two arm-covering portions and wherein one of the front closures is arranged so as to be approximately centered between the arm-covering portions, when the front closures are closed while the protective garment is being worn.

4. The protective garment of claim 1, wherein the protective garment has two limb-covering portions and wherein the front closure of the outer shell is arranged so as be to approximately centered between the limb-covering portions, when the front closures are closed while the protective garment is being worn.

5. The protective garment of claim 1, wherein the protective garment has two arm-covering portions and wherein the front closure of the outer shell is arranged so as to be approximately centered between the arm-covering portions, when the front closures are closed while the protective garment is being worn.
